(19) United States
(12) Patent Application Publication
(10) Pub. No.: US 2007/0227998 A1
(43) Pub. Date: Oct. 4, 2007

(54) Rubber-tyred gantry crane using city electric supply as a power source

(76) Inventors: Gang He, Shanghai (CN); Junjie Tang, Shanghai (CN); Qing Gao, Shanghai (CN)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/709,310

(22) Filed: Feb. 21, 2007

(30) Foreign Application Priority Data
Feb. 21, 2006 (CN) 200610024001.5

(51) Int. Cl. B66C 19/00

(52) U.S. Cl. 212/344

(57) ABSTRACT

The present invention discloses a rubber-tyred gantry crane using city electric supply as its power source, comprising a gantry, a feed circuit and a plurality of electromotors, said plurality of electromotors being provided at appropriate positions of the gantry and being powered by the feed circuit, wherein the feed circuit is connected with the city electric supply via a cable. The RTG further comprises a cable reel disposed on one side of the gantry, and said cable is wound around the cable reel, with one end of the cable being connected to the feed circuit of the RTG and the other end of the cable going into a cable socket on the ground through a cable lead disposed on a saddle girder of the gantry under the cable reel, and extending along the cable socket to be connected with a joint box for city electric supply disposed at an end terminal of the cable socket. When the RTG travels, the cable reel pulls up and takes off the cable according to the distance between the RTG and the joint box. The RTG according to the present invention use city electric supply as its power source, thus making the rubber-tyred gantry crane has effects of high efficiency, economy and environmental protection.

### FIELD OF THE INVENTION

The present invention relates to an equipment for container loading/unloading and transporting, and more particularly to a rubber-tyred gantry crane taking electric supply from city electric supply network as its power source.

### BACKGROUND

Nowadays, all the rubber-tyred gantry cranes in the world use a fuel diesel engine as a power source. With the continuously rising of the oil price all over the world, fuel supply of the market tends to be increasingly tension in supply, while international trade volume in the world market becomes larger and larger, so that the number and scale of ports and harbors for container shipping becomes larger and larger, as well as the percentage of the fuel costs in the operating costs. As seen from statistical data, consumption costs of diesel oil in a rubber-tyred gantry crane (RTG) taking a diesel generating set as its power source occupies a considerably large proportion. In some ports, the fuel costs per year have exceeded a hundred million RMB Yuan. The consumption of the fuel is not economic and severely pollutes environment. Therefore, it is an important task to substitute the rubber-tyred gantry crane using the fuel diesel engine as the power source with a rubber-tyred gantry crane using the city electric supply as a more economical power source.

### SUMMARY

To solve the above technical problem, the present invention provides a rubber-tyred gantry crane (hereinafter referred to as RTG for concise) using the city electric supply as its power source.

According to the present invention, providing a rubber-tyred gantry crane using city electric supply as its power source, comprising a gantry, a feed circuit and a plurality of electromotors provided at appropriate positions of the gantry and being powered by the feed circuit, wherein the feed circuit is connected with the city electric supply via a cable.

According to an embodiment, the rubber-tyred gantry crane using city electric supply as its power source further comprises a cable reel disposed on one side of the gantry, and said cable is wound around the cable reel, with one end of the cable being connected to the feed circuit and the other end of the cable being provided with a plug.

According to an embodiment, the rubber-tyred gantry crane using city electric supply as its power source, wherein, there is a mounting platform for the cable reel provided on one side of the gantry.

According to an embodiment, the rubber-tyred gantry crane using city electric supply as its power source, wherein, a cable socket is provided on a lane right under the cable reel, an end terminal of the cable socket is provided with a joint box for city electric supply, the joint box is provided with a socket for adapting the plug of the cable, wherein the cable hangs down from the cable reel and goes into the cable socket, and extends along the cable socket to be connected with the joint box at the end terminal of the cable socket.

According to an embodiment, the rubber-tyred gantry crane using city electric supply as its power source, further comprising a cable lead disposed at the bottom of the gantry, wherein the cable lead is above the cable socket, and the cable goes into the cable socket through the cable lead after hanging down from the cable reel.

When the RTG according to the present invention travels, the cable reel pulls up and takes off the cable according to the distance between the RTG and the joint box, thereby assuring the power supply of the RTG in working area. Such a RTG using city electric supply is simpler in structure than a RTG using fuel diesel engine, is safe and reliable, is easy for maintenance, has high efficiency, is economic and has no pollution. Thus, it can be called a green and environmental protection type RTG.

### BRIEF DESCRIPTION OF THE DRAWINGS

The embodiments of the present invention are illustrated in conjunction with the drawings, in which:

FIG. 1 is a front view of a rubber-tyred gantry crane using the city electric supply as its power source according to an embodiment of the present invention;

FIG. 2 is a view taken in the direction of A of the rubber-tyred gantry crane using the city electric supply as its power source according to the embodiment of the present invention; and

FIG. 3 is a schematic view of the lanes on the yards of a port for traveling of the rubber-tyred gantry crane using the city electric supply as its power source according to the present invention.

### DETAILED DESCRIPTION OF PREFERRED EMBODIMENTS

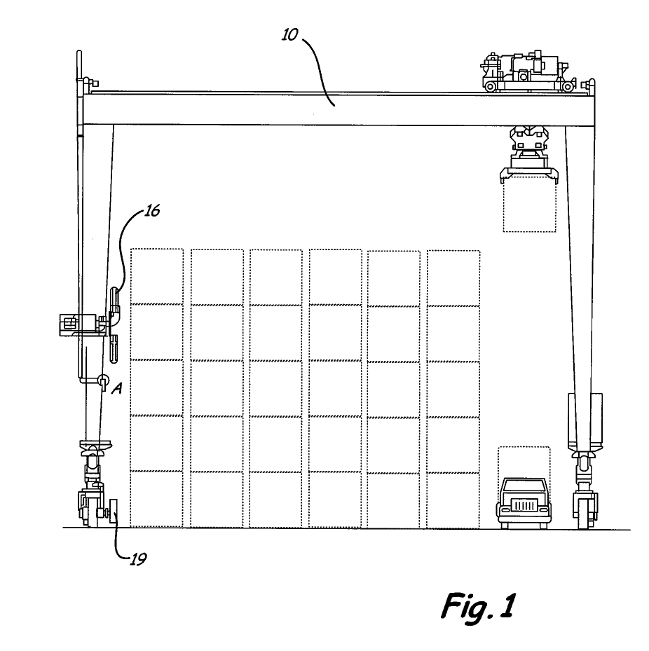

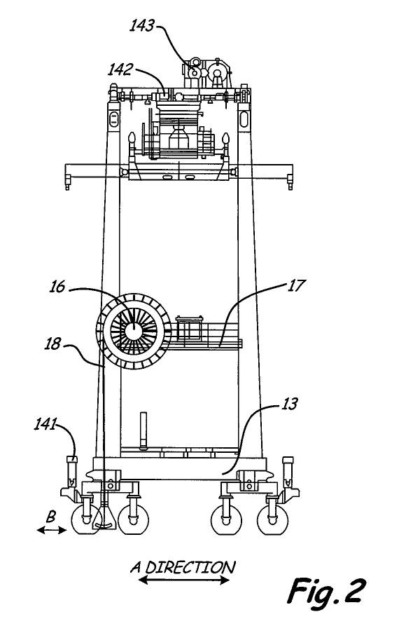

Referring to FIG. 1 and FIG. 2, an RTG 100 using the city electric supply as its power source of the present invention comprises a gantry 10, a feed circuit and a plurality of electromotors including a gantry driving motor 141, a trolley driving motor 142 and a lifting motor 143. The RTG is characterized in that the feed circuit may be connected to the city electric supply via a cable 18, thereby using the city electric supply as the power source. As the cable 18 needs to be pulled up and taken off according to the distance between the RTG and the electric network when the RTG travels, there is needed a mechanism for pulling up and taking off the cable. The following is an example but not a limitation to the present invention.

FIG. 1 is a front view of a rubber-tyred gantry crane using the city electric supply as its power source according to an embodiment of the present invention. As shown, the RTG 100 comprises a cable reel 16 and a cable lead 19. The cable reel 16 is disposed on a platform 17 disposed on end frame on one side of the gantry 10, for pulling up and taking off the cable 18. The height of the platform 17 may be changed as required. The cable lead 19 is disposed on a frame steelwork 13 at the bottom on one side of the gantry 10. The cable 18 is wound around the cable reel 16. One end of the cable is connected to the feed circuit of the RTG 100 for supplying power to the plurality of electromotors through the feed circuit, and the other end of the cable is provided with a quick plug for connecting with a joint box of city electric.

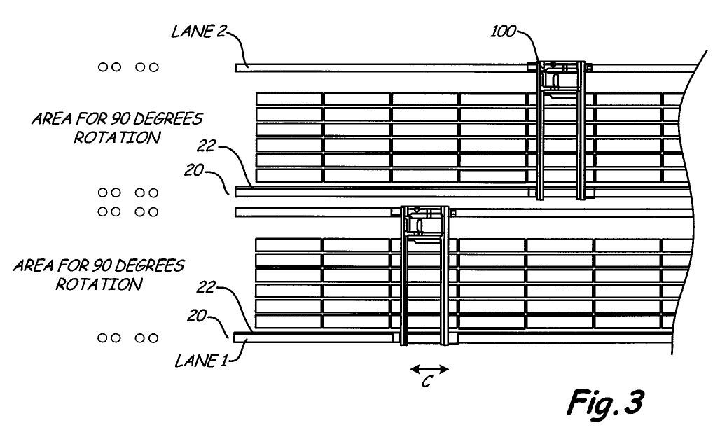

Referring to FIG. 3, lanes are provided right under the cable reel 16. FIG. 3 illustrates two lanes, lane 1 and lane 2. And there are cable sockets 22 corresponding to the respective lanes. The cable socket 22 extends in the same direction of the lane, i.e., the traveling direction of the RTG 100 (the direction shown by the arrow C in FIG. 3). The joint box 20 is provided at one end terminal of the cable socket 22 for connecting with the city electric supply network for power supply. The joint box 20 is provided with a socket for adapting the plug of the cable. One end of the cable 18 hangs down from the cable reel 16 and goes into the cable socket 22 through a cable lead 19 on the ground level, and then is connected to the joint box 20 provided at the one end terminal of the cable socket 22. All of the portions of the cable 18 on the ground are within the cable socket 22.

The plane of the cable reel 16 is parallel to the traveling direction of the RTG 100 (the direction shown by the arrow B in FIG. 2), so that the cable 18 can be pulled up and taken off freely. The cable lead 19 approaches the ground level for leading the cable 18 to make the cable straight and always within the cable socket 22, without being pressed against by the tyres of the RTG 100 and by other transportation vehicles, thus assuring the safety of the cable 18. However, the cable lead 19 is not necessarily required. If the mounting height of the cable reel is lower, the deadweight of the cable could ensure that the cable accurately falls within the cable socket on the ground.

Although the cable reel 16, cable 18 and cable lead 19 of the present invention shown in FIG. 1 are disposed at the inside of the gantry 10, however, the cable reel 16, cable 18 and cable lead 19 may also be disposed at the outside of the gantry 10 according to the arrangement requirements of the port.

FIG. 3 is a schematic view of the lanes on the yards of a port. In FIG. 3, two lanes of the RTG 100 are shown as lane 1 and lane 2, respectively. When the RTG 100 works on the lanes, the quick plug of the cable 18 plugs in the joint box 20 at the end of the lane, and the portions of the cable on the ground are within the cable socket 22. When the RTG 100 operates at the position of each container along the lane 1 of the yard, the cable reel 16 pulls up and takes off the cable 18 according to the distance between the RTG 100 and the joint box 20, to assure continuous power supply, and the power cable 18 is made straight by the cable lead 19 to make the cable 18 always within the cable socket 22 to assure the safety of the cable.

When the RTG 100 needs the gantry turn 90 degrees to travel to another lane 2, the cable 18 of the RTG 100 is pulled out from the joint box 20 of the lane 1 and is plugged into the joint box of the lane 2, to using the joint box of lane 2 as for power supply and to operate along the lane 2.

By the above solution, the power supply of the RTG 100 can be changed to power supply by the city electric supply network. Such a RTG using city electric supply is simpler in structure than a RTG using fuel diesel engine, is safe and reliable, is easy for maintenance, has high efficiency, is economic and has no pollution. Thus, it can be called a green and environmental protection type RTG.

What is claimed is:

1. A rubber-tyred gantry crane using city electric supply as its power source, comprising:
a gantry;
a feed circuit; and
a plurality of electromotors, provided at appropriate positions of the gantry and being powered by the feed circuit, wherein the feed circuit is connected with the city electric supply via a cable.

2. The rubber-tyred gantry crane using city electric supply as its power source according to claim 1, further comprising:
a cable reel disposed on one side of the gantry, wherein said cable is wound around the cable reel, with one end of the cable being connected to the feed circuit and the other end of the cable being provided with a plug.

3. The rubber-tyred gantry crane using city electric supply as its power source according to claim 1, wherein,
a cable socket is provided on a lane right under the cable reel, an end terminal of the cable socket is provided with a joint box for city electric supply, the joint box is provided with a socket for adapting the plug of the cable, wherein the cable hangs down from the cable reel and goes into the cable socket, and extends along the cable socket to be connected with the joint box at the end terminal of the cable socket.

4. The rubber-tyred gantry crane using city electric supply as its power source according to claim 3, further comprising:
a cable lead disposed at the bottom of the gantry, wherein the cable lead is above the cable socket, and the cable goes into the cable socket through the cable lead after hanging down from the cable reel.
